(19) United States
(12) Patent Application Publication
(10) Pub. No.: US 2018/0016980 A1
(43) Pub. Date: Jan. 18, 2018

(54) MODULAR COMPLEX FOR PRODUCTION OF EFFECTIVE POWER THROUGH COMBUSTION OF LIQUID AND GASEOUS FUELS

(71) Applicant: Nikola Kolev, Varna (BG)

(72) Inventor: Nikola Kolev, Varna (BG)

(21) Appl. No.: 15/549,845

(22) PCT Filed: Jan. 27, 2016
(86) PCT No.: PCT/BG2016/000003

§ 371 Date: Aug. 9, 2017

(30) Foreign Application Priority Data
Feb. 10, 2015 (BG) 111927

(51) Int. Cl. F02C 6/06; F02B 33/40; F01B 17/02; F02B 37/00

(52) U.S. Cl. CPC F02C 6/06; F02B 37/00; F02B 33/40; F01B 17/02; F05D 2220/40; F05D 2240/35

(57) ABSTRACT

The modular complex for production of effective power through combustion of liquid and gaseous fuels comprises two modules: Module for production of heat in a single combustion chamber for burning various liquid and gaseous fuel types, connected to the inlet of gas turbocharger for production of energy carrier (compressed air) with flow rate and pressure required for production of planned power and frequency of rotation; Module for transformation of carrier energy into effective power with mechanical system of variable volumes and distribution system for charging and discharging of air, comprising distribution plate with straight shaft with slots to connect compressed air from cylinder filling channels through the motion of crankgear pistons from top to bottom dead center and the channels for discharging of cylinders through the motion of pistons from bottom to top dead center, whereas low pressure and temperature values eliminate the necessity for cooling system, fuel injection system, gas distribution system and starters. The final result represents increment of effective efficiency of modular complex to over 60 percent, elimination of complicated systems, reduction of fuel consumption, materials and labor costs as well as toxic oxides and noise levels.

### 1. FIELD OF APPLICATION

The modular complex for production of effective power through combustion of liquid and gaseous fuels is applicable in all transport and stationary equipment driven by internal combustion engines.

### 2. CURRENT STATE OF MACHINERY

At present transport and stationary units are driven by internal combustion engines. These engines burn the fuel in closed spaces under high pressure requiring complex systems for injection of fuel, gas distribution and cooling. The final result from such construction is a loss of combustion power of 60-70 percent. The internal combustion engine represents a complex yet inefficient system.

### 3. TECHNICAL ESSENCE

The modular complex for production of effective power through combustion of liquid and gaseous fuels increases the effective efficiency above 60 percent by changing the production of energy, transfer of energy to mechanical volumetric system and transformation of energy into power with two modules.
Module for production of heat through combustion of liquid or gaseous fuels in combustion chamber. Combustion chamber is connected to the inlet of gas turbine with one or more working stages for transformation of heat energy into torque. Connected to turbine shaft are one or more impellers of centrifugal compressor for transformation of turbine energy into carrier (compressed air) with flow rate and pressure determined with the design for production of effective power at the required rotation frequency of the output shaft. Energy carrier is transferred and distributed with pipes and manifolds to consumer—mechanical system of variable volumes.
Module with variable volumes for transformation of carrier energy into effective power and effective revolutions via crankshaft fixed in crankcase and connected with pistons via connecting rods to modify the volume in cylinders (crankgear). Cylinders are closed by plate with windows for charging with energy carrier on one side and for discharging on the other side. Distribution manifold feeds compressed air to cylinder charging windows when the piston is moving from top to bottom dead center, and a hole cut in cylinder camshaft fitted plate longitudinal hole connects pressure manifold with cylinder windows. The rear edge of cylinder camshaft closes charging window (7-10°) before bottom dead center, to expand air and reduce pressure.

With the piston at bottom dead center, the camshaft has turned at 180 degrees to position when the section slot provides connection between cylinder space and exhaust window to exhaust manifold and centrifugal compressor suction side or ambiance.

Provision is also made for closed contour of air circulation.

High pressure pipe is equipped with branch for transfer of compressed air into combustion chamber and charging the receiver with compressed air required for initial ignition or electric motor.

Low pressure pipe is equipped with branch for fitting of filter for supplementary air or suction of flow rate.

The modular complex for production of effective power through combustion of liquid and gaseous fuels has the following advantages in comparison with internal combustion engines:
Produces heat energy in a single combustion chamber utilizing various liquid and gaseous fuel types under low pressure;
Transforms heat energy into mechanical one and energy carrier with the help of the well-known turbocharger. Turbocharger parameters—air (energy carrier) flow rate and pressure are determined by the volumes to be filled in the unit for production of effective power. The power increases with the increment of air pressure.

Turbochargers demonstrate efficiency of around 65 percent, small dimensions and weight according to publications.
Mechanical efficiency of the module for transformation of carrier source into effective power exceeds 95 percent based on the tenfold reduction of the forces acting on pistons, small specific pressures on shaft bearing supports (up to 2,0.MN/m²) and reduced friction losses.
Low air (energy carrier) temperature up to 120° C. eliminates the necessity for cooling system (heat sink, pump, water skirt).
Eliminated necessity for fuel injection pumps, injectors and piping.
Eliminated complicated gas distribution system with camshaft, lifting rods, rockers, shafts, valves, valve springs, and gears.
Eliminated starter and tooth crown.
Eliminated cylinder head.
Reduced noise and toxic oxide levels.
Reduced costs for metals, energy, tools and labor.
Eliminated losses of effective power for driving water pump, camshaft and gas distribution system.
Production of more power with low pressure of inert gas (energy carrier).
Enhanced combustion energy effect of 60-70 percent.

### 4. DESCRIPTION OF ATTACHED ILLUSTRATIONS

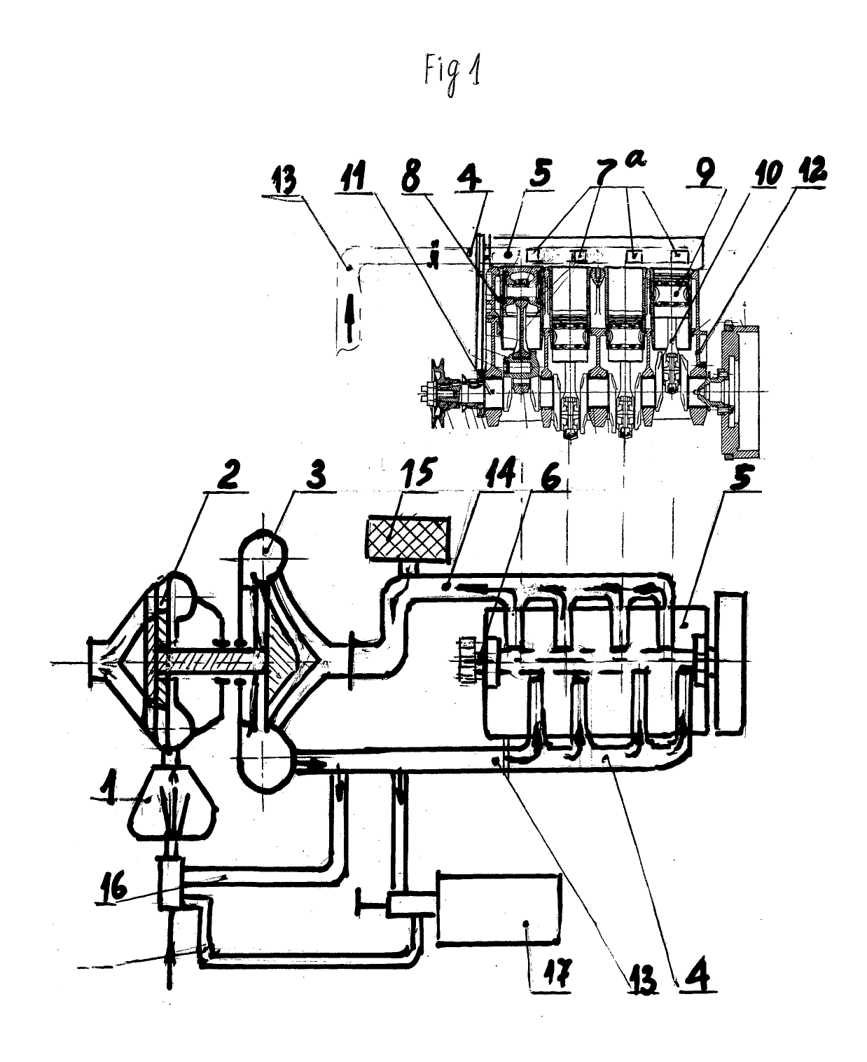

Illustrated on FIG. 1 is a modular complex for production of effective power through combustion of liquid and gaseous fuels

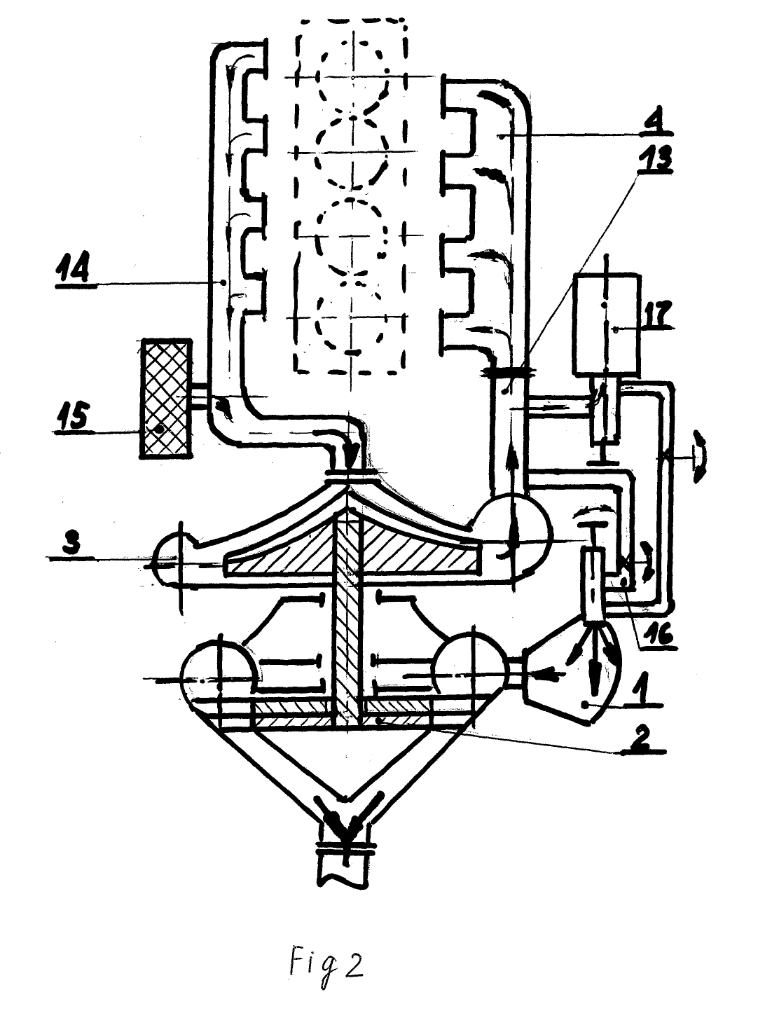

Illustrated on FIG. 2 is a heat production module, comprising:
Combustion chamber 1 with burner for combustion of liquid or gaseous fuel. Burner 1 is charged with air for initial ignition from compressed air receiver 17, and with the compressor 3 in operation—from pipeline 16.
Gas turbine 2 with one or more stages for transformation of heat energy into mechanical power and centrifugal compressor 3 connected to turbine 2 shaft for production of energy carrier (compressed air).

Combustion chamber 1, turbine 2 and compressor 3 (turbocharger) are designed for production of flow rate and pressure required for filling the working volumes of mechanical system (cylinders) with pressures to provide desired effective power at design frequency of rotation of output shaft. Energy carrier is distributed to working volumes from manifold 4 (e.g. 4 volumes). Exhaust air is discharged via manifold 14 to the suction side of compressor 3 in a closed cycle or to ambiance. The pipeline to compressor 3 suction side is equipped with a branch with filter 15 to compensate the consumed combustion air and regulate gas temperature.

Fuel and air flow rates to burner are connected in a common regulation system providing complete combustion of fuels at the permissible gas temperature upstream gas turbine 2.

Pipelines for transfer of energy carrier and manifolds are less than 100 cm long and non-metal made, withstanding temperature up to 120° C. and pressure up to 10 bar.

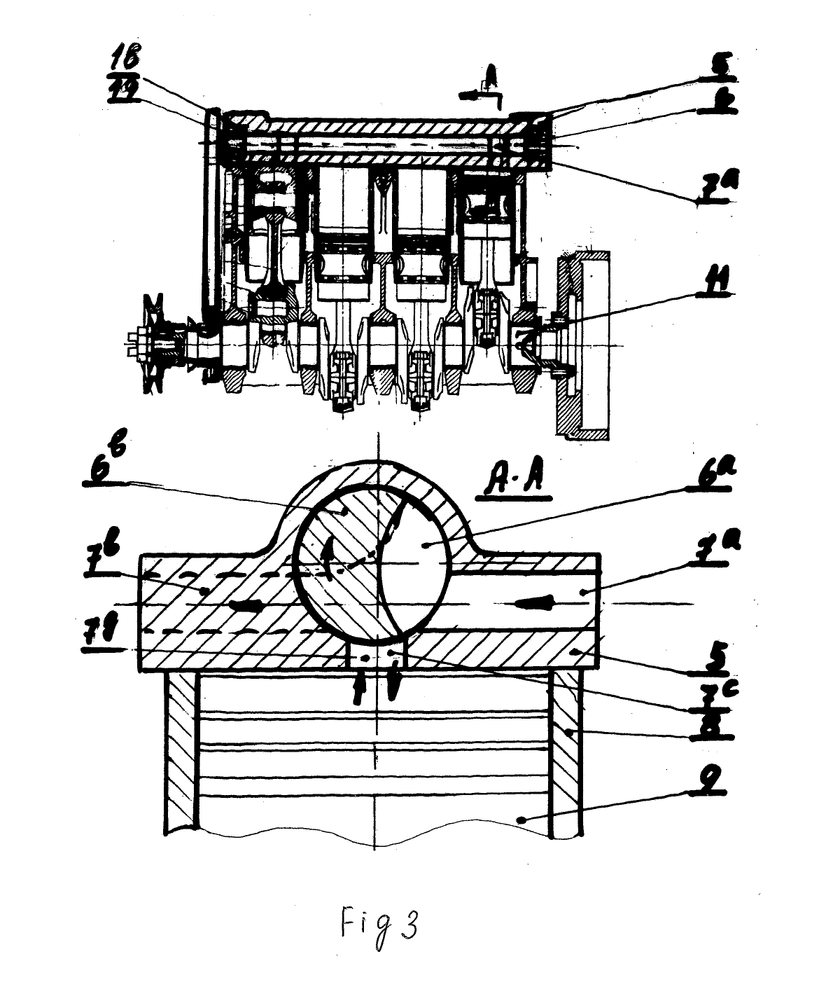

Illustrated on FIG. 3 is the module for transformation of carrier energy into effective power comprising variable volume unit (cylinders 8, crankcase 12, pistons 9, connecting rods 10, and shaft 11) with cylinder holes closed by the plate 5 with windows 7^{a} and 7^{c} for feeding air into cylinder 8, and 7^{b} and 7^{d} for discharging exhaust air. Variable volume unit may have different design.

Compressed air is fed to cylinder when the shaft 6 fixed in the cylindrical hole of the plate 5 along diameter length, connects windows 7^{a} and 7^{e} for feeding air to cylinder 8 through section window 6^{a}. The slot 6^{a} connects compressed air from manifold 4 with cylinder 8 when the piston 9 has overpassed top dead center by 2-3 degrees.

The shaft 6 rotates in line with the revolutions of the crankshaft 11.

The rear edge of slot 6^{a} closes window 7^{a} before piston 9 comes bottom dead center. When piston 9 comes to bottom dead center, section window 6^{b} located on shaft 6 against exhaust window 7b, connects cylinder 8 via window 7^{d} for discharging air via manifold 14 to the suction side of compressor 3, or into ambiance.

Each piston 9 makes one stroke from top to bottom dead center for one rotation of shaft 11. The plate 5 may be manufactured from nonmetal material.

### 5. EXEMPLARY SOLUTIONS

The modular complex for production of effective power through combustion of liquid and gaseous fuels may be manufactured under the original design of combustion chamber 1, gas turbine 2, compressor 3, and variable volume unit corresponding to output shaft revolutions. Modular complex may also incorporate existing turbochargers for passenger vehicles and trucks able to produce flow rate determined by the total volume of cylinders multiplied by the frequency of rotation of output shaft and with air pressure 3-7 bar.

### Example

Effective power Ne=74 kW at frequency of rotation of output shaft n=2800 min⁻¹ produced with turbocharger flow rate 12 m³/min and air pressure Pk=5 bar, and maximum force 400 kg. With air pressure Pk=13 bar, the power is 45 kW, and the maximum force acting on piston is 240 kg.

With the increment of piston area, the effective power increases too.

Distribution plate 5 closes cylinder holes, feeds air to and from cylinder through windows 7^{a} and 7^{c} and discharges air from cylinder through windows 7^{d} and 7^{b}, with feeding and discharging controlled in time by camshaft 6 with section slots 6^{a} for filling the cylinder and 6^{b} for discharging air.

The shaft 6 is seating on two bearings, sealed at both ends with lip seals and rotating in line with the frequency of rotation of the output (crank) shaft.

The original production of modular complex takes place at the existing facility with reduced costs and simplified outfitting.

### 6. APPLICATION (USE) OF INVENTION

The modular complex for production of effective power through combustion of liquid and gaseous fuels is applicable in all means of transport without modifications to transmissions, and with enhanced efficiency of production and consumption, reduced noise and toxic wastes levels as well as fuel consumption costs.

1. Combustion of liquid and gaseous fuels and transformation of combustion energy into energy carrier (compressed air) with flow rate, pressure and temperature, takes place in a module for production of heat through combustion of liquid and gaseous fuels in combustion chamber (1), the latter connected to the inlet of gas turbine (2) with one or more stages for transformation of heat into shaft torque, to which are fixed one or more impellers of the centrifugal compressor (3) (turbocharger set) for transformation of turbine (2) energy into energy carrier (compressed air) by compressor (3) with flow rate, pressure and temperature for production of effective power with design frequency of rotation of output shaft (11), whereas transfer of energy carrier to mechanical system is done through pipe with distribution manifold (4), (13), and the manifold with pipe (14) leads the exhaust air to the suction side of compressor (3) or into ambiance, and air losses are compensated with filter (15).

2. The modular complex for production of effective power through combustion of liquid and gaseous fuels in accordance with claim 1, distinguished with the fact that carrier energy is transformed into power by a module for establishment of variable volumes comprising cylinders (8), pistons (9), connecting rod (10), and crankshaft (11), positioned in crankcase (12), whereas cylinder holes (8) are closed by plate (5) with windows (7^{a} and 7^{c}) for filling cylinder space with air through section window (6^{a}), cut along camshaft (6) diameter, when the piston overpasses top dead center and closes window (7^{a}) when the piston is upstream bottom dead center, and the air is discharged from cylinder space through windows (7^{b} and 7^{d}) in plate (5) through section window (6^{b}) in camshaft (6) the latter rotating in line with the frequency of rotation of the crankshaft (11), and pistons make a stroke from top to bottom dead center, whereas air consumption represents a multiple of the working volume of cylinders (8) and shaft (11) frequency, plus combustion and leak losses.
